(19) United States
(12) Patent Application Publication
(10) Pub. No.: US 2002/0097238 A1
(43) Pub. Date: Jul. 25, 2002

(54) Three dimensional method of decorating on a curvilinear surface

(76) Inventor: Alan Tura, Warren, OH (US)

Correspondence Address: Harpman & Harpman, 819 Southwestern Run, Youngstown, OH, 44514, US

(21) Appl. No.: 09/766,930

(22) Filed: Jan. 23, 2001

(51) Int. Cl. G06T 15/00

(52) U.S. Cl. 345/419

(57) ABSTRACT

A method for producing three-dimensional composite images by the use of color-coded images wherein the perceived depth of the viewed image is based on the color registration on the objects being viewed. More specifically, the use of two-dimensional indicia with multiple color sequence registration on a curvilinear surface wherein the angle of viewer inclination imparts a perceived registration from the viewable surface so as to elevate visualization sequence portions of the encoded color image in relation to non-enhanced image portions dependent on the relative position of the view images on the curvilinear surface.

### BACKGROUND OF THE INVENTION

1. Technical Field

This invention relates to processes of applying images to two-dimensional surfaces, particularly Easter egg decoration in which images are viewed and perceived as having three-dimensional depth.

2. Description of Prior Art

Prior art processes for decorating Easter eggs have heretofore been divided into two general classifications, specifically color dyeing and applied decoration. Typically Easter egg color dyeing uses Easter egg color dyes, soluble and water and vinegar mix that are transferred solid colors onto the egg surface. Some variations and techniques have been used heretofore to achieve coating portions of the egg surface with non-permeable coating such as wax and then dyeing. Removal of the non-permeable coating reveals non-dyed portions of the egg surface which then secondary decorative appliqués can be achieved.

Applied decoration encompasses many decorative processes including hand painting of designs on the egg surface as well as direct transfer by decal or applied designs that have decorative indicia thereon.

### SUMMARY OF THE INVENTION

Accordingly, it is the object of the present invention to provide a novel process which overcomes prior art material limitations with respect to enhancing an egg surface when decorated and viewed.

It is also an object of the invention to provide a decorative process which combines multiple decoration and three-dimensional viewing displays that can be applied as a single multiple dimensional surface enhancement.

Three three-dimensional imagery provides an enhanced decorative surface when viewed normally and a true 3-D effect of selected portion of the decoration when viewed through color-coded 3-D glasses having typically blue and red lens.

### DESCRIPTION OF THE DRAWINGS

FIG. 1 is a front perspective view of an egg shaped surface decorated in accordance with the steps of this invention;

FIG. 2 is an enlarged front plan view of the decorative portion illustrating the 3-D color registration enhancements of the design;

FIG. 3 is a graphic illustration of the viewing angle inclination on a decorated curvilinear surface illustrating the enhanced visual perspective of the invention process;

FIG. 4 is a perspective view of an egg shaped surface illustrating the visual 3-D effect when viewed through 3-D glasses; and

FIG. 5 is an enlarged view of a portion of the combined two and three-dimensional color registrations to achieve the visual effect when viewed at accilinear degrees.

### DESCRIPTION OF THE PREFERRED EMBODIMENTS

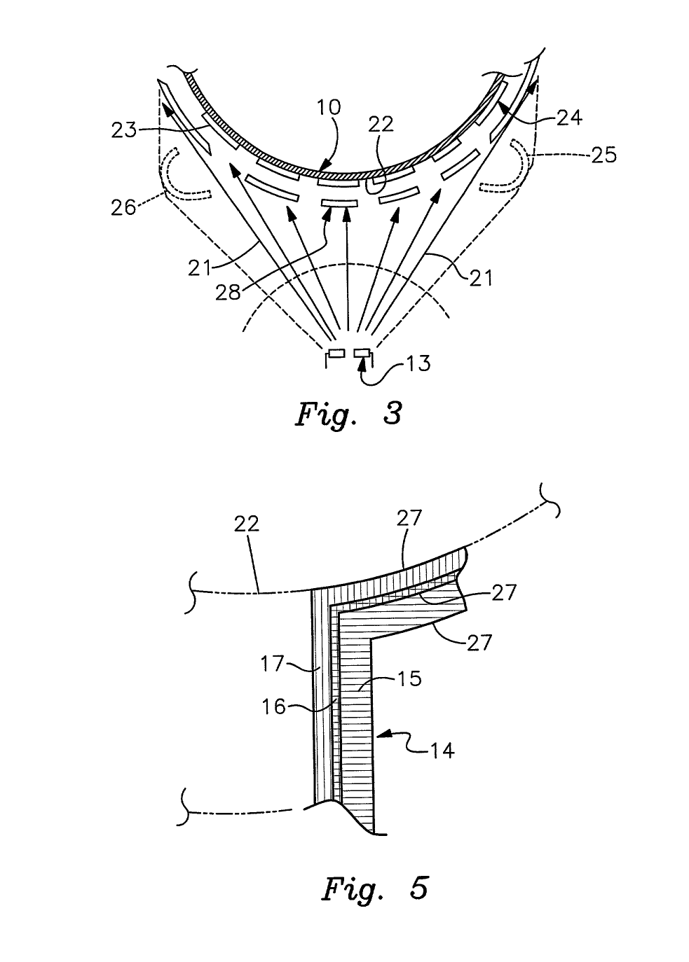

Referring now to FIGS. 1, 2 and 3 of the drawings, an egg 10 is illustrated having indicia 11 on its outer exterior surface 12. The invention is drawn to the nature of the indicia 11 which is applied as decoration to the egg surface 12 in a unique manner to enhance the decorative visualization of the decorated egg 10 when viewed through special lens 13 represented in FIG. 3 of the drawings. The application of different color contrast including the primary colors 14 specifically red 15, yellow 16, blue 17 and green 18 and a method step process that is directed to both order of application and position of the “primary colors 14” to one another and non-specific background colors generally indicated at 19.

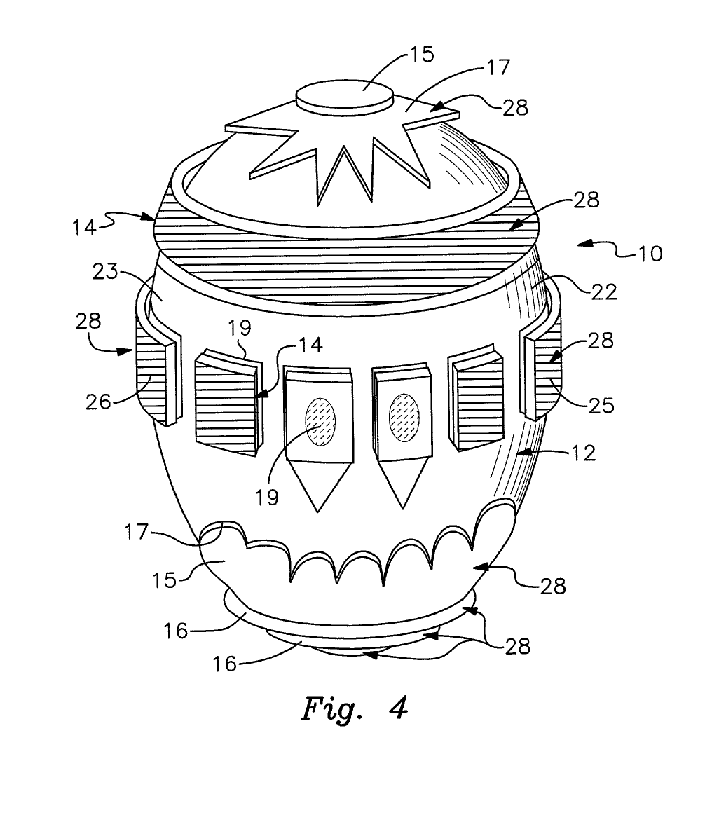

In this example chosen for illustration, the primary colors 14 have been applied so that when viewed through the specialized lens 13 impart a three-dimensional effect to the decoration as generally illustrated in FIG. 4 of the drawings. It is the manner and inter-relationship of the applied primary colors 14 and background colors 18 that define an enhanced three-dimensional effect when viewed. The primary colors 14 are illustrated by broken and dotted lines to illustrate a typical application under the method of the invention. The specialized glass lenses 13 are in this example of a red and blue lens. The primary color of red therefore appear distant whereas parts of the image which appear in the foreground are colored blue with the middle ground or intermediate distance being colored yellow or green.

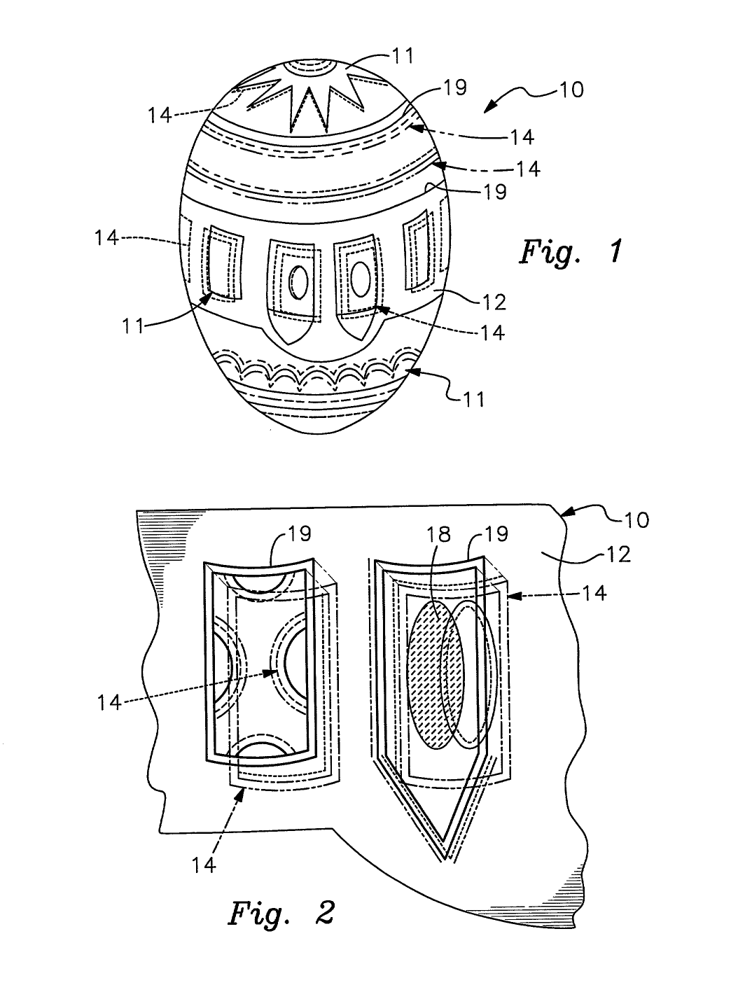

Referring to FIGS. 1 and 2 of the drawings, a decorative image is illustrated on a non-primary color outline such as black. This image is overlaid with the combination of primary colors 14 in an offset registration that will enhance the image portions when viewed through the specialized lenses 13. Some portions of the applied decorative indicia 11 will appear to float above the surface 12 of the egg 10 at 28 as seen in FIG. 4 while other colors not subject to the 3-D enhancement and illusion remain viewable on the surface 12of the egg 10.

Referring now to FIG. 3 of the drawings, it will be seen that the angular inclination of the viewer (not shown) helps achieve the three-dimensional effect in that the lenses 13 allow each eye only to see a specialized color which results in a color registration difference. The discrepancy existing in the respective color images which were perceived between the viewer's eyes is translated by the viewer's brain to provide a sense of depth and thus the three-dimensional effect. Given that the viewer's sight line illustrated by line of site arrows 21 is varied by the actual difference in distance perceived between the closest viewable surface at 22 of the egg 10 and the respective contoured edge surfaces at 23 and 24, the three-dimensional effect is distorted so that the latter images visually elongate thus being interpreted by the brain as on the same plane as that of the front most image giving the perceived wrap around effect of the respective image portions indicated at 25 and 26 in FIG. 3 of the drawings as shown in dotted lines.

Referring now to FIG. 5 of the drawings, an enlarged portion of the overlay color registration can be seen in which the colors are used as to define the principle registration borders within one another given the black outlines at 27. By using the interdependency of primary colors 14 registration when viewed at an oblique angle as the respective edge surfaces 22 and 23 hereinbefore described, the normal visualization of the image is distorted and thus wrap around effect is achieved.

It will be apparent to those skilled in the art that other color registration viewing can be achieved by the use of polarized lenses wherein the low and high dispersion material is used in a clear lens and prism lens which isolate color registration between lens. The image enhancing effect on the curvilinear surface of the egg 10 is still achieved using the basic 3-D aspects in combination with unique angle inclination as hereinbefore described. It will be evident to those skilled in the art that various changes and modifications may be made therein without departing from the spirit of the invention, therefore I claim:

1. A method and process for imparting three-dimensional visualization of indicia on a curvilinear surface of a three-dimensional object comprising the steps of
a. applying a graphic design indicia of non-reactive base colors to the curvilinear surface
b. applying a graphic design indicia of reactive primary colors in multiple overlapping registration to said non-reactive base colors
c. viewing said composite graphic indicia registration on said curvilinear surface through selective colored viewing lenses to define a 3-D visualization thereof
d. viewing portions of said composite graphic indicia from a central viewing position to impart multiple angular inclination viewing angles to said compound graphic indicia registration
e. viewing portions of said compound graphic indicia registration of reactive primary colors appearing in dimensional relationship to non-reactive and reactive primary colors

2. The method step set forth in claim 1 wherein said non-reactive base color includes black.

3. The method steps set forth in claim 1 wherein said reactive base colors comprises blue, red and green.

4. The method steps set forth in claim 1 wherein said viewing portions of said compound graphic indicia registration from a controlled viewing position impart angular inclination of reactive graphic indicia colors imparting a wrap around effect.

5. The method step set forth in claim 4 wherein said angular inclinations of viewed compound graphic indicia is of multiple overlapping primary non-reactive and specific reactive colors.

6. The method steps set forth in claim 1 wherein said primary colors are fluorescent.

7. The method steps set forth in claim 1 wherein said imparting three-dimensional visualization of indicia on a curvilinear surface step of non-reactive and reactive primary colors applied by monolithic design transfer sheets of pre-printed multiple color registration of graphic indicia.

8. The method step set forth in claim 1 of selective colored viewing lens comprises, lens from the group consisting of colored, polarized and prismatic lenses providing viewer color isolation imparting image registration shift.
